(19) United States
(12) Patent Application Publication
(10) Pub. No.: US 2007/0282974 A1
(43) Pub. Date: Dec. 6, 2007

(54) DISTRIBUTION SERVER, MULTIFUNCTION APPRATUS AND DISTRIBUTION SERVER SYSTEM

(75) Inventors: Koichi NAGOSHI, Fukuoka (JP); Ikuo YOSHIDA, Fukuoka (JP); Takeshi OOTSUKA, Fukuoka (JP); Takayuki FUKUSHIMA, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/757,541

(22) Filed: Jun. 4, 2007

(30) Foreign Application Priority Data
Jun. 6, 2006 (JP) 2006-157705

(51) Int. Cl. G06F 15/16

(52) U.S. Cl. 709/217

(57) ABSTRACT

A distribution server distributes over a network, menu information that contains information for executing a job using a multifunction apparatus and information for identifying the job. The distribution server sets at least a portion of the information for executing the job using the multifunction apparatus as additional information added later to the menu information, and adds an input instruction to the menu information for executing additional information input using the multifunction apparatus. The multifunction apparatus that obtains the menu temporarily determines a portion of a fixed job for execution.

### BACKGROUND OF THE INVENTION

1. Field of the Invention

The present invention relates to a distribution server, a multifunction apparatus, and a distribution server system that includes the distribution server and the multifunction apparatus, the distribution server distributing over a network a menu that is used by the multifunction apparatus to execute a job.

2. Description of Related Art

Conventionally, technology is known that allows a multifunction apparatus connected to a network to obtain a menu from a distribution server for executing frequently performed regular jobs (e.g., copying, facsimile transmission, scanned data distribution, and the like) and executes the jobs by using the menu (Related Art 1). The technology generates menu information, which includes a menu name and information for executing a regular job associated with the menu name, on the distribution server in advance. When distributing scanned data from the multifunction apparatus, for instance, the multifunction apparatus obtains the menu information from the distribution server, and displays on a panel a menu screen based on the obtained menu information. The menu information defines a destination to save the scanned data (e.g., an address of a terminal or a document control server, or the like) and a location to save the same (e.g., a folder or the like). The user can specify the save destination and location on the menu screen displayed on the panel. Then, the multifunction apparatus scans a document; transmits the scanned data to the specified save destination via the distribution server; and saves the scanned data to the specified save location.

[Related Art 1] Japanese Patent Laid-open Publication 2004-118549

The conventional technology disclosed in Related Art 1 above, however, has a problem where the user cannot perform a job not included in the previously generated menu information when using the menu on the multifunction apparatus to perform a predetermined job.

To distribute the scanned data generated on the multifunction apparatus to a terminal or a server on the network, for example, a save destination or location not defined in the menu information cannot be added for temporary use.

Further, to transmit the scanned data to the terminal or the server on the network, for example, a predetermined keyword cannot be added temporarily in the scanned data, or an authorization password cannot be added temporarily that permits reading, editing, or printing and the like of the scanned data file.

Furthermore, to transmit the scanned data to the terminal or the server on the network, for example, a password cannot be entered that permits execution of the transmission job for ensuring security of the job execution.

### SUMMARY OF THE INVENTION

The present invention is provided to address the above-described problems in the conventional art. A main object of the present invention is to provide a distribution server, a multifunction apparatus, and a distribution server system that includes a distribution server and a multifunction apparatus, wherein said distribution server comprises: a memory that stores menu information, an input screen setter that sets input screen information and stores the input screen information on said memory; and a distributor that distributes the menu information and the input screen information to a network, in response to requests from the network, and wherein said multifunction apparatus comprises: a network controller that communicates with said distribution server and receives menu information and input screen information from said distribution server; a screen that displays a instruction menu according to the menu information; and a controller that sends the request to said distribution server via said network controller in response to instruction through the instruction menu, and receives the screen information from said distribution server via said network controller, the screen information being transmitted by said distribution server in response to the request, said screen displaying an input screen to input additional information to the multifunction apparatus.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 illustrates a system configuration of a distribution server system according to the present embodiment;

FIG. 2 is a function block diagram of a distribution server;

FIG. 3 illustrates configuration examples of soft-keyboard capability information;

FIG. 4 is a flowchart illustrating a procedure for generating input screen information;

FIG. 5 illustrates configuration examples of menu information;

FIG. 6 is a flowchart illustrating a procedure for obtaining the menu information so as to execute a job using a multifunction apparatus; and

FIGS. 7A to 7C illustrate display examples of an input screen for additional information on the multifunction apparatus.

### DETAILED DESCRIPTION OF PREFERRED EMBODIMENTS

According to the first aspect of the present invention, a distribution server, which distributes over a network, menu information that contains information for executing a job using a multifunction apparatus and information for identifying the job, includes: an additional information setter that sets at least a portion of the information for executing the job using the multifunction apparatus as additional information added later to the menu information, and that adds an input instruction to the menu information that allows the multifunction apparatus to input the additional information.

Accordingly, at least a portion of the information (additional information) for executing the job using the multifunction apparatus can be added later to the menu information from the multifunction apparatus. Therefore, it is possible to flexibly execute a job by temporarily determining a portion of a fixed job to be executed through the use of the menu information.

According to the second aspect of the present invention, the distribution server further includes: an input screen information generator that generates input screen information that allows the multifunction apparatus to display an input screen for the additional information on the multifunction apparatus; and a distributor that distributes the input screen information to the multifunction apparatus that has obtained the menu information.

According to the third aspect of the present invention, the input screen information includes information related to characters displayed on the input screen that explains the additional information.

According to the fourth aspect of the present invention, the input screen information includes information related to a soft-keyboard displayable on the multifunction apparatus, the soft-keyboard being selected according to an attribute of the additional information.

According to the fifth aspect of the present invention, the input screen information includes information related to an address book available on the multifunction apparatus, the address book being selected according to an attribute of the additional information.

According to the sixth aspect of the present invention, the input screen information includes information related to whether the additional information entered on the multifunction apparatus is displayed as is on the input screen or is replaced with a predetermined symbol to be displayed, the additional information being selected according to an attribute of the additional information.

According to the seventh aspect of the present invention, the distribution server further includes: an input result obtainer that obtains an input result of the additional information on the multifunction apparatus; an comparator that compares the input result of the additional information with a previously set input condition; and a job execution permitter that instructs the multifunction apparatus whether to execute a job based on the comparison result.

Accordingly, execution of a job is allowed only when the additional information input from the multifunction apparatus is appropriate, thereby properly executing the job using the multifunction apparatus. When setting additional information for comparison as a password that allows execution of a job, an input result of the password that allows execution can be compared against a predetermined comparison password, thereby properly achieving security related to the job execution.

According to the eighth aspect of the present invention, a multifunction apparatus, which obtains from a distribution server via a network, menu information that contains information for executing a job using a multifunction apparatus and information for identifying the job, includes: an input instruction obtainer that obtains through the menu information, an input instruction for entering additional information later added to the menu information as the information for executing the job; an input screen information obtainer that obtains from the distribution server, input screen information for displaying an input screen for the additional information, when the additional information is entered according to the input instruction; and an input screen display that displays the input screen based on the input screen information.

Accordingly, at least a portion of the information (additional information) for executing the job using the multifunction apparatus can be added later to the menu information through the input. Therefore, it is possible to flexibly execute a job by temporarily determining a portion of a fixed job to be executed through the use of the menu information. In addition, by displaying the input screen of the additional information based on the input screen information, the user can easily input the additional information.

According to the ninth aspect of the present invention, a distribution server system includes: the distribution server according to the first aspect of the present invention; and the multifunction apparatus according to the second aspect of the present invention.

The embodiments of the present invention are explained in the following, with reference to the above-described drawings.

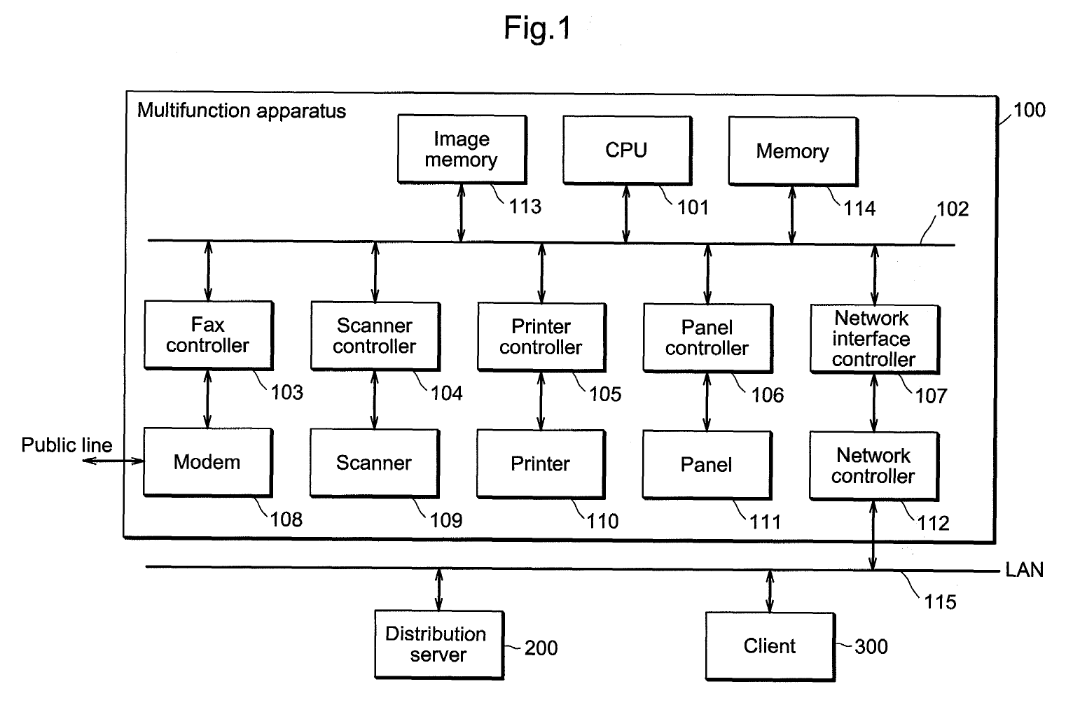

FIG. 1 illustrates a system configuration of a distribution server system according to the present embodiment. The figure details a function block of a multifunction apparatus. As shown in FIG. 1, the following controllers are connected to CPU 101 via internal bus 102 in multifunction apparatus 100: fax controller 103, scanner controller 104, printer controller 105, panel controller 106, and network interface controller 107. Fax controller 103 transfers image data to and from image memory 113 via modem 108 so as to transmit and receive a facsimile. Scanner controller 104 controls scanner 109 so as to read a draft, and stores image data in image memory 113. Printer controller 105 prints from printer 110 the image data stored in image memory 113. Panel controller 106 retrieves menu information and additional information thereof stored in memory 114, and displays the information on panel 111. Network interface controller 107 controls network controller 112 so as to transfer data to and from distribution server 200 and client 300 on network 115.

Further, a plurality of multifunction apparatuses having a similar structure to multifunction apparatus 100 are connected to network 115. A computer may be used as distribution server 200 or client 300. Shown as an example of network 115 is a LAN, which may be substituted with a WAN.

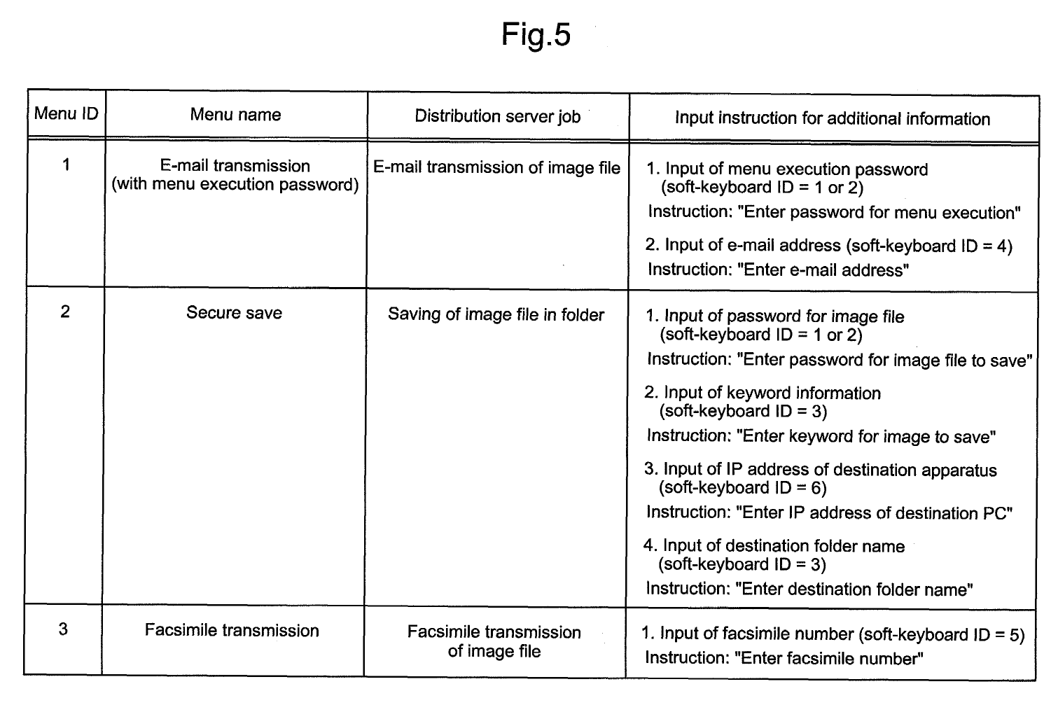

The “menu information” herein mainly includes information for executing a job using multifunction apparatus 100 and information for identifying the job, as described hereinafter with reference to FIG. 5. Multifunction apparatus 100 obtains the menu information from distribution server 200 via network 115, and displays on panel 111 a predetermined menu screen based on the menu information. A user selects a desired job from the menu screen so as to execute the job.

The “additional information” herein means at least a portion of the information for executing the job using multifunction apparatus 100 included in the menu information. The additional information is set for adding information later to the menu information. When executing a job that distributes scanned data to a terminal or a server on the network, for instance, it is possible to set as the additional information, an IP address of a save destination terminal or server, or a folder name of a save location. It is further possible to set as the additional information, a keyword added in the scanned data to be distributed or an authorization password for permitting reading, editing, printing, or the like of a scanned data file. Furthermore, it is possible to set as the additional information, an execution permission password for permitting execution of scanned data transmission. The user can enter the information set as the additional information on multifunction apparatus 100, so as to specify the information temporarily for job execution.

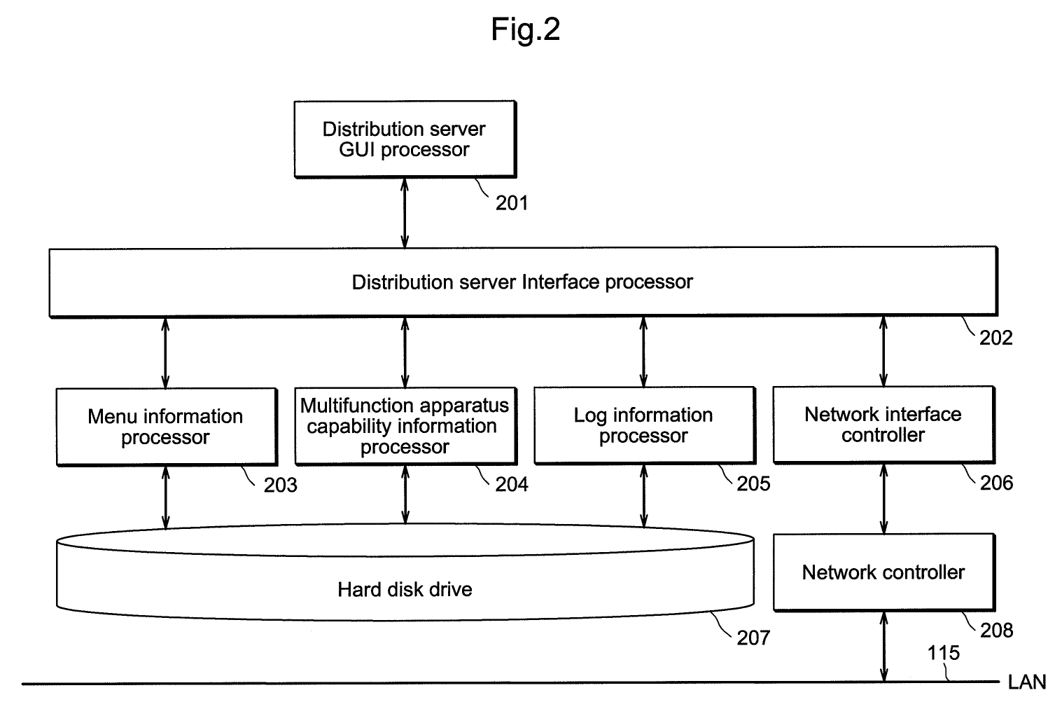

FIG. 2 is a function block diagram of distribution server 200. In FIG. 2, distribution server GUI processor 201 executes GUI processing on distribution server 200. Such GUI processing includes generation of menu information for a job to be executed using multifunction apparatus 100; setting of additional information thereof; generation of input screen information for displaying an input screen used for entering the additional information on panel 111 of multifunction apparatus 100; display of soft-keyboard capability information and address book capability information of multifunction apparatus 100; and the like. To generate the menu information, the user sets the additional information on the screen of distribution server GUI processor 201 and provides an input instruction that allows multifunction apparatus 100 to input additional information. Then, the input instruction is written to the menu information. Distribution server GUI processor 201 is further connected via distribution server interface processor 202 to menu information processor 203; multifunction apparatus capability information processor 204, which is related to the soft-keyboard capability information and address book capability information of multifunction apparatus 100; log information processor 205; and network interface controller 206.

Menu information processor 203 writes and reads data to and from hard disk drive 207, the data being of the menu information, the additional information thereof, and the input screen information for entering the additional information, which are generated or set on the screen of distribution server GUI processor 201. Multifunction apparatus capability information processor 204 writes and reads data to and from hard disk drive 207, the data being of the capability information of a soft-keyboard displayable on multifunction apparatus 100 connected to network 115, and of an address book stored in multifunction apparatus 100. Log information processor 205 writes and reads data to and from hard disk drive 207, the data being of a function executed on distribution server 200 as log information. Hard disk drive 207 stores the menu information, the additional information, the input screen information for entering the additional information, the soft-keyboard capability information, the address book capability information, the log information, and the like. In order to exchange the data with another system, hard disk drive 207 controls the data in a commonly-used data format, such as XML, CSV and other file formats. Network interface controller 206 transmits and receives the data via network controller 208 to and from multifunction apparatus 100, client 300, another distribution server, and another system that are on the network 115. The user can use client 300 so as to access distribution server 200 and execute a variety of setting operations.

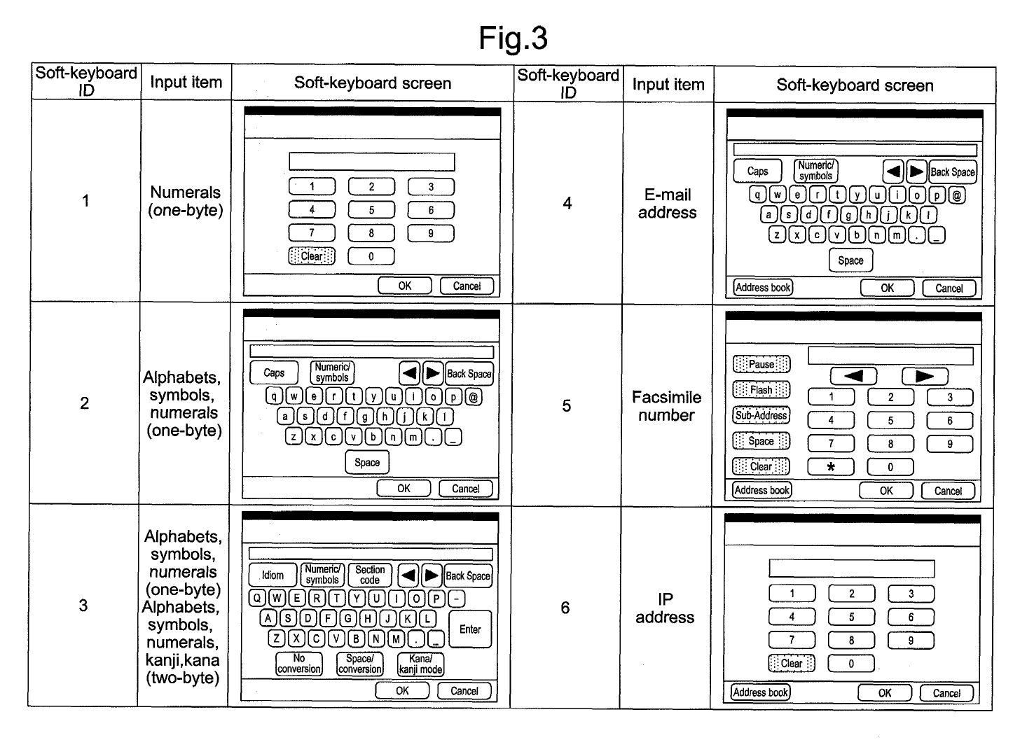

The soft-keyboard capability information herein is information related to types of the soft-keyboard displayable on panel 111 of multifunction apparatus 100. As shown in FIG. 3, for example, soft-keyboard identification information (soft-keyboard ID) is provided per soft-keyboard type. FIG. 3 shows soft-keyboard examples for entering numerals (ID=1); alphabets, symbols, and numerals (one-byte) (ID=2); alphabets, symbols, and numerals (one-byte), and alphabets, symbols, numerals, kanji (Chinese characters), and kana (Japanese syllabic characters) (two-byte) (ID=3); an e-mail address (ID=4); a facsimile number (ID=5); and an IP address (ID=6). The soft-keyboard types are not limited to the examples shown herein, but various soft-keyboard types displayable on the multifunction apparatus can be registered. The address book capability information is information related to types of the address book stored in multifunction apparatus 100. Address book identification information is provided per address book type (an address book related to a facsimile number, an e-mail address, or the like), for example.

Explained below are specific operations of the distribution server system configured as above.

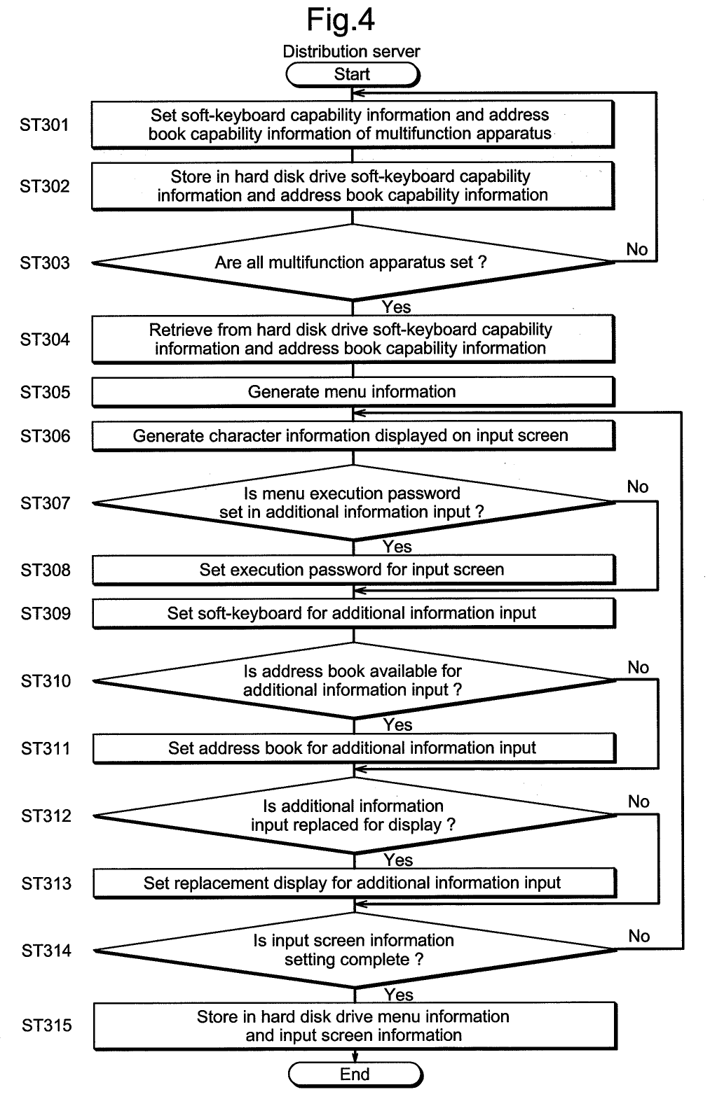

FIG. 4 is a flowchart illustrating a procedure for generating the input screen information on the distribution server in order to enter the additional information on the multifunction apparatus. The user first sets the soft-keyboard capability information displayable on the multifunction apparatus and the address book capability information associated with the address book stored in the multifunction apparatus, through distribution server GUI processor 201 of distribution server 200 (ST 301). Then, the soft-keyboard capability information and address book capability information entered through distribution server GUI processor 201 are stored in hard disk drive 207 (ST 302). In the step above, the soft-keyboard capability information and the address book capability information can be stored per multifunction apparatus using the identification information of the capability information. Upon completion of storing the soft-keyboard capability information and the address book capability information for all multifunction apparatuses managed by distribution server 200 (ST 303: Yes), the procedure proceeds to generation of the menu information.

Distribution server GUI processor 201 retrieves and displays on the display, the soft-keyboard capability information and the address book capability information per multifunction apparatus stored in hard disk drive 207 (ST 304). Then, the menu information is generated that includes a menu name of a job (identification information of a job) to be executed using the multifunction apparatus and information for executing the job (ST 305). In the generation of the menu information herein, the user specifies the menu name of the job to be executed, and selects the information for executing the job through distribution server GUI processor 201. The information for executing the job may include, for instance, a paper size, a printing color, and other information for a copy job; an e-mail address, image quality, a file format, and other information for an e-mail transmission job; and a facsimile number, a draft paper size, image quality, and other information for a facsimile transmission. Further, the additional information is set, with reference to the soft-keyboard capability information and address book capability information on the display. Then, an input instruction for executing additional information input on the multifunction apparatus is generated and added to the menu information.

The menu information generated as above includes, as shown in FIG. 5, a menu ID for identifying a menu item; a menu name; a job description; and input instruction information for executing the additional information input on the multifunction apparatus, for example. Although not shown in FIG. 5, the menu information includes information for executing each of the above-described jobs. For the e-mail transmission job, for instance, the multifunction apparatus that obtains the menu information is provided with information such as image quality, a file format, and the like. The multifunction apparatus is also instructed to enter a password for menu execution, and then to enter an e-mail address.

Subsequently, the procedure proceeds to generation of the input screen information for the additional information of the menu. First generated is character information for displaying on the input screen an explanation of the additional information entered on the multifunction apparatus (ST 306). The character information enables display of character information for explaining the additional information on the input screen of the multifunction apparatus, thus providing the user with a more appropriate input instruction.

Then, it is determined whether or not to set a password for permitting execution of the job on the multifunction apparatus using the menu information (ST 307). When the execution password is required, a setting is provided for requesting input of the execution password on the input screen (ST 308). Subsequently, a setting is provided of the soft-keyboard for entering the additional information on the multifunction apparatus (ST 309). In this step, a soft-keyboard suitable for attributes of the additional information is set to be selected from among soft-keyboards displayable on the multifunction apparatus. For instance, when the additional information entered on the multifunction apparatus is a password, which includes only one-byte numerals, a soft-keyboard for entering one-byte numerals alone (ID=1 of FIG. 3) is set. Then, it is determined whether or not the multifunction apparatus has an address book available when entering the additional information thereon (ST 310). When the multifunction apparatus has such an available address book, an address book suitable for attributes of the additional information is set to be selected among address books stored in the multifunction apparatus (ST 311). Further, it is determined whether or not to replace an input result of the additional information entered on the multifunction apparatus with a predetermined symbol with echo back and display the predetermined symbol (ST 312). When the input needs to be replaced for display, the input result of the additional information is set to be replaced with the predetermined symbol with echo back (ST 313). In this case, for example, an entered password or the like for which security needs to be ensured, is replaced and displayed as “****” with echo back.

Such input screen information is generated according to the attributes of each additional information added to the above-described menu information. The input screen information can be set repeatedly for a plurality of times. When settings of all the input screen information are completed (ST 314: Yes), the menu information and the input screen information are stored to hard disk drive 207 from menu information processor 203 (ST 315). Based on the input screen information generated as above, the multifunction apparatus displays a screen for entering the additional information, thus allowing the user to easily enter the information.

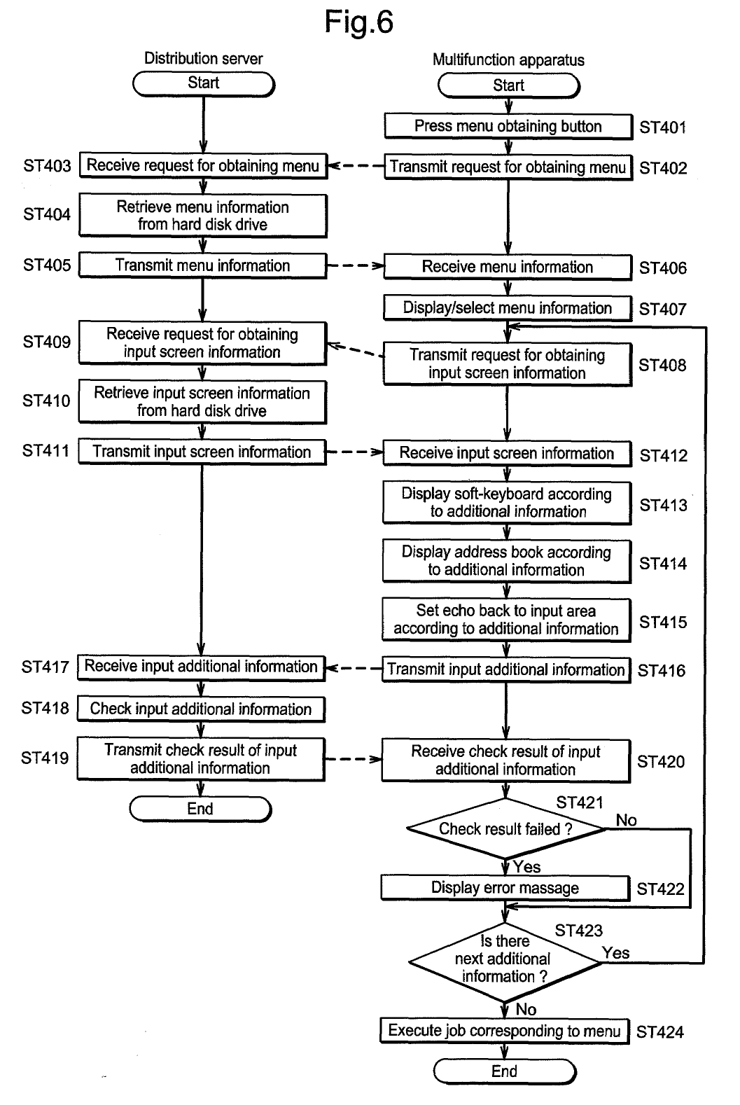

FIG. 6 is a flowchart illustrating a procedure for obtaining the menu information from the distribution server so as to execute a job using a multifunction apparatus. When a user presses a menu obtaining button on panel 111 of multifunction apparatus 100, panel controller 106 detects the pressing of the button (ST 401), and network controller 112 transmits a menu obtaining request to distribution server 200 via network interface controller 107 (ST 402).

When receiving the menu obtaining request from multifunction apparatus 100 at network interface controller 206 through network controller 208 (ST 403), distribution server 200 retrieves menu information stored in hard disk drive 207 from menu information processor 203 through distribution server interface processor 202 (ST 404). Subsequently, distribution server 200 transmits the retrieved menu information to multifunction apparatus 100 from network interface controller 206 through distribution server interface processor 202 (ST 405).

When multifunction apparatus 100 receives the menu information from distribution server 200 (ST 406), panel controller 106 displays on panel 111 a menu screen based on the menu information. Then, the user selects a menu item (a selection button for a job to be executed) displayed on the menu screen (ST 407). Multifunction apparatus 100 then transmits to distribution server 200 a request for obtaining input screen information for entering additional information related to the menu item selected by the user (ST 408).

When receiving from multifunction apparatus 100 the request for obtaining the input screen information (ST 409), distribution server 200 retrieves input screen information stored in hard disk drive 207, from menu information processor 203 through distribution server interface processor 202 (ST 410). Subsequently, distribution server 200 transmits the retrieved input screen information to multifunction apparatus 100 from network interface controller 206 via distribution server interface processor 202 (ST 411).

When multifunction apparatus 100 receives from distribution server 200 the input screen information (ST 412), panel controller 106 sets display of the soft-keyboard on panel 111 as an input screen for entering the additional information, based on the input screen information (ST 413). Panel controller 106 further sets display of the address book stored in multifunction apparatus 100, based on the input screen information (ST 414). Furthermore, panel controller 106 sets whether or not to replace the display of an input area for additional information with a predetermined symbol with echo back for display, based on the input screen information (ST 415). The user can operate the displayed soft-keyboard and select a predetermined address from the displayed address book when entering the additional information.

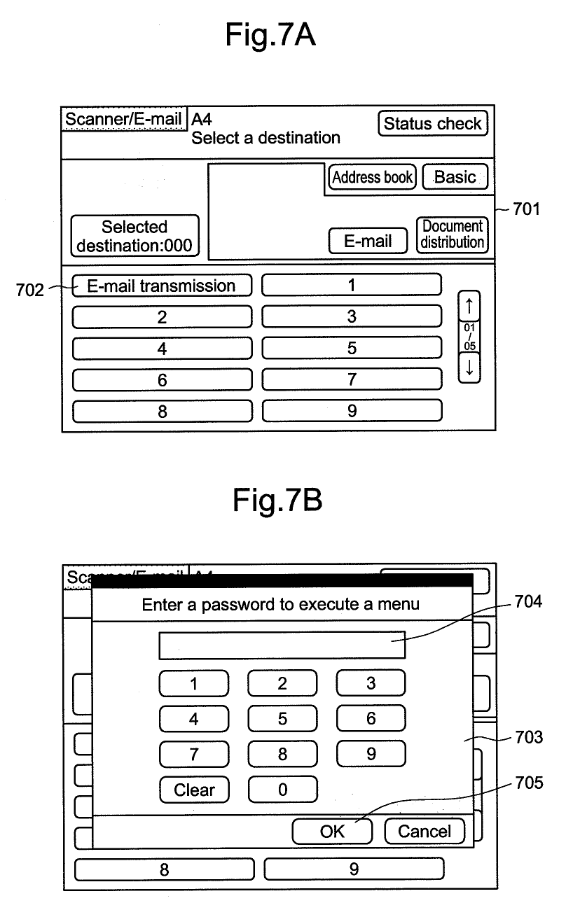

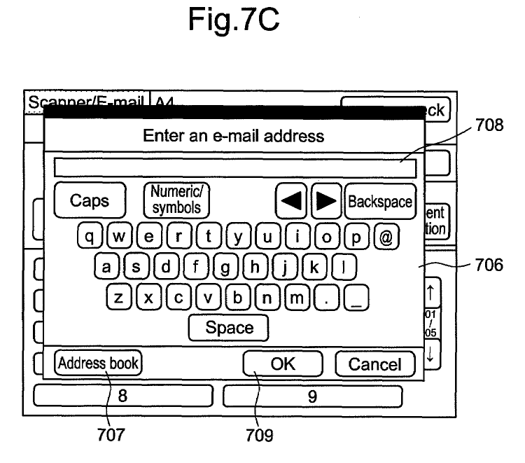

Described below is a case where a user enters the additional information when transmitting e-mail, with reference to FIGS. 7A to 7C that illustrate examples of the input screen. When the user presses an e-mail transmission button (a menu item) 702 on menu screen 701 (FIG. 7A) displayed on panel 111 based on the menu information, soft-keyboard 703 (corresponding to ID=1 of FIG. 3) is displayed (FIG. 7B), the soft-keyboard being set based on the input screen information received from distribution server 200. The user then operates numeric keys on displayed soft-keyboard 703 in order to enter a menu execution password in input area 704, and presses OK button 705 in order to complete password input. Then, soft-keyboard 706 (corresponding to ID=4 of FIG. 3) is displayed (FIG. 7C), the soft-keyboard being set based on the input screen information received from distribution server 200. The user herein presses address book button 707 in order to retrieve an address book stored in multifunction apparatus 100, the address book being set based on the input screen information. The user selects an e-mail address included in the address book so as to display the e-mail address on input area 708, and presses OK button 709 so as to complete e-mail address input. When multifunction apparatus 100 has no address book, the user can use alphabet and numeric keys so as to enter an e-mail address, instead of using address book button 707. As described above, using the soft-keyboard and the address book allows the user to easily enter the additional information.

When the user completes entering the additional information as described above, multifunction apparatus 100 transmits the input results to distribution server 200 (ST 416). When receiving from multifunction apparatus 100 the input results of the additional information (ST 417), distribution server 200 compares the input results with previously set input conditions (ST 418). When an execution permission password is entered as the additional information, for example, multifunction apparatus 100 checks the input password against a previously set password for comparison. When an e-mail address is entered as the additional information, multifunction apparatus 100 checks the number of characters and an address format of the input e-mail address against previously set conditions for the number of characters and address format. Then, distribution server 200 transmits the check results to multifunction apparatus 100 (ST 419).

Subsequently, when receiving the check results from distribution server 200 (ST 420), multifunction apparatus 100 confirms the received check results (ST 421). When the check results fail, multifunction apparatus 100 displays an error message on panel 111 (ST 422). In this case, multifunction apparatus 100 can be set to request input for the same additional information in a subsequent step, so as to allow repeated input for the same additional information. Finally, when input is provided to all the additional information, the job associated with the menu item selected by the user is executed (ST 424).

According to the distribution server, the multifunction apparatus, and the distribution server system according to the present embodiment, at least a portion of the information for executing the job using the multifunction apparatus can be added later to the menu information. Therefore, it is possible to flexibly execute a job using the multifunction apparatus by temporarily determining a portion of a fixed job to be executed through the use of the menu information. Therefore, it is useful to be applied to the distribution servers that distribute over a network a menu for executing a job using a multifunction apparatus, the multifunction apparatuses that executes the job utilizing the menu, and the distribution server systems having such a distribution server and a multifunction apparatus.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based on the Japanese Patent Application No. 2006-157705 filed on Jun. 6, 2006, entire content of which is expressly incorporated by reference herein.

What is claimed is:

1. A distribution server that communicates with a multifunction apparatus over a network, comprising:
a memory that stores menu information, the menu information containing job execution information for executing job by the multifunction apparatus;
an input screen setter that sets input screen information for the multifunction apparatus and stores the input screen information on said memory; and
a distributor that distributes the menu information and the input screen information to the multifunction apparatus responding to requests from the multifunction apparatus, the multifunction apparatus displaying a operation menu and the input screen according to the menu information and the input screen information.

2. The distribution server according to claim 1, wherein the input screen contains a soft keyboard to input additional information to the multifunction apparatus.

3. The distribution server according to claim 2, wherein the additional information comprises password information.

4. The distribution server according to claim 2, wherein the additional information comprises mail address information.

5. A multifunction apparatus that communicates with a distribution server over a network comprising:
a network controller that communicates with the distribution server and receives menu information and input screen information from the distribution server;
a screen that displays a instruction menu according to the menu information; and
a controller that sends a request to the distribution server via said network controller in response to instruction through the instruction menu, and receives the screen information from the distribution server via said network controller, the screen information being transmitted by the distribution server in response to the request,
wherein said screen displays an input screen to input additional information to the multifunction apparatus.

6. The multifunction apparatus according to claim 5, wherein the input screen contains a soft keyboard to be displayed on said screen.

7. The multifunction apparatus according to claim 6, wherein the additional information comprises password information.

8. The multifunction apparatus according to claim 6, wherein the additional information comprises mail address information.

9. A distribution server system comprising a distribution server and a multifunction apparatus,
wherein said distribution server comprises:
a memory that stores menu information;
an input screen setter that sets input screen information and stores the input screen information on said memory; and
a distributor that distributes the menu information and the input screen information to a network, in response to requests from the network, and
wherein said multifunction apparatus comprises:
a network controller that communicates with said distribution server via the network and receives menu information and input screen information from said distribution server;
a screen that displays a instruction menu according to the menu information; and
a controller that sends the request to said distribution server via said network controller in response to instruction through the instruction menu, and receives the screen information from said distribution server via said network controller, the screen information being transmitted by said distribution server in response to the request, said screen displaying an input screen to input additional information to the multifunction apparatus.

10. The distribution server according to claim 9, wherein the input screen contains a soft keyboard to input additional information to the multifunction apparatus.

11. The distribution server according to claim 10, wherein the additional information comprises password information.

12. The distribution server according to claim 10, wherein the additional information comprises mail address information.
